(19) United States
(12) Patent Application Publication
(10) Pub. No.: US 2025/0192503 A1
(43) Pub. Date: Jun. 12, 2025

(54) SYSTEM AND METHOD FOR TEMPORAL SHAPING OF A LASER PULSE

(71) Applicant: Government of the United States as represented by the Secretary of the Air Force, Wright-Patterson AFB, OH (US)

(72) Inventors: Brendan Mcgann, Tipp City, OH (US); Campbell Carter, Dayton, OH (US); Stephen Hammack, Beavercreek, OH (US)

(21) Appl. No.: 18/918,300

(22) Filed: Oct. 17, 2024

Related U.S. Application Data
(60) Provisional application No. 63/606,772, filed on Dec. 6, 2023.

(51) Int. Cl. H01S 3/00; H01S 3/092; H01S 3/1123; H01S 3/16

(52) U.S. Cl. CPC H01S 3/0057; H01S 3/092; H01S 3/1123; H01S 3/1611; H01S 3/1643

(57) ABSTRACT

A system for temporal shaping of a laser pulse. The system includes a flow chamber, the flow chamber having an entry aperture and an exit aperture. A compressed gas supply and a vacuum source are in fluid communication with the flow chamber. A laser is positioned in operative alignment to produce a laser beam that enters the entry aperture and exits the exit aperture. A focusing lens is operatively positioned to focus the laser beam through the entry aperture. A collimating lens is operative positioned to collimate the laser beam exiting the exit aperture. A vacuum regulator is in fluid communication with the vacuum source. The combination of the compressed gas supply and vacuum regulator allow for control of fluid pressure in the flow chamber.

### GOVERNMENT INTEREST

The invention described herein may be manufactured and used by or for the Government of the United States for all government purposes without the payment of any royalty.

### FIELD OF THE INVENTION

The embodiments herein generally relate to temporal shaping of laser pulses.

### BACKGROUND

Temporal shaping of laser pulses involves a laser shuttering process useful in applications like laser-induced breakdown spectroscopy (LIBS). LIBS is an experimental technique in which a pulsed laser is focused at or in a target medium generating a plasma through dielectric breakdown. LIBS is widely used for chemical composition analysis, though most often for analysis of solid- or liquid-phase samples rather than gases.

A continuing, unaddressed need exists for systems and methods to achieve improved temporal shaping of laser pulses. Improvements can improve processes such as LIBS to measure material characteristics, particularly to achieve measurements of gases at temperatures below ignitable thresholds.

### BRIEF DESCRIPTION OF THE DRAWINGS

The embodiments herein will be better understood from the following detailed description of the drawings, in which:

FIG. 1 is a schematic diagram of an example system according to an embodiment herein; and

FIG. 2 is a graph showing laser pulse profiles.

### DETAILED DESCRIPTION OF THE INVENTION

Various non-limiting embodiments of the present disclosure will now be described to provide an overall understanding of the principles of the structure, function, and use of the apparatuses, systems, methods, and processes disclosed herein. One or more examples of these non-limiting embodiments are illustrated in the accompanying drawings. Those of ordinary skill in the art will understand that systems and methods specifically described herein and illustrated in the accompanying drawings are non-limiting embodiments. The features illustrated or described in connection with one non-limiting embodiment may be combined with the features of other non-limiting embodiments. Such modifications and variations are intended to be included within the scope of the present disclosure.

Reference throughout the specification to “various embodiments,” “some embodiments,” “one embodiment,” “some example embodiments,” “one example embodiment,” or “an embodiment” means that a particular feature, structure, or characteristic described in connection with any embodiment is included in at least one embodiment. Thus, appearances of the phrases “in various embodiments,” “in some embodiments,” “in one embodiment,” “some example embodiments,” “one example embodiment, or “in an embodiment” in places throughout the specification are not necessarily all referring to the same embodiment. Furthermore, the particular features, structures or characteristics may be combined in any suitable manner in one or more embodiments.

The examples discussed herein are examples only and are provided to assist in the explanation of the apparatuses, devices, systems, and methods described herein. None of the features or components shown in the drawings or discussed below should be taken as mandatory for any specific implementation of any of these the apparatuses, devices, systems, or methods unless specifically designated as mandatory. For ease of reading and clarity, certain components, modules, or methods may be described solely in connection with a specific FIG. Any failure to specifically describe a combination or sub-combination of components should not be understood as an indication that any combination or sub-combination is not possible. Also, for any methods described, regardless of whether the method is described in conjunction with a flow diagram, it should be understood that unless otherwise specified or required by context, any explicit or implicit ordering of steps performed in the execution of a method does not imply that those steps must be performed in the order presented but instead may be performed in a different order or in parallel.

In the operation of laser-induced breakdown spectroscopy (LIBS), the optical emissions from the breakdown plasma can be subsequently collected and spectrally analyzed. The emissions of the plasma are determined by the plasma temperature and the ions/atoms/molecules present during the recombination processes as the plasma cools. The plasma temperature and composition are determined by the properties of the focused laser (pulse energy, temporal profile, wavelength, spatial profile, focusing optics) and the medium into/onto which the laser is focused (molecular composition, temperature, pressure). During the formation of a laser-induced plasma, except in specific cases, initial ionization occurs through a multiphoton ionization process. Examples of cases in which multiphoton ionization is not the initial ionization mechanism include laser breakdown in the presence of strong electromagnetic fields which produce free electrons, and laser breakdown on solid metals where absorption can occur through free-free interactions in the conduction band (provided the laser photon energy is sufficient i.e. shorter wavelength). In gaseous media that are not exposed to strong electromagnetic fields initial ionization occurs through a multiphoton ionization process as the energies of photons typically used (e.g., 2.3 electronvolts [eV] for a 532 nm laser and 1.2 eV for a 1064 nm laser) can be much lower than the ionization energies of the typical gaseous media explored (e.g., 12.1 eV for O₂, 15.6 eV for N₂, 15.8 eV for Ar, 10.5 eV for C₂H₄, 12.6 eV for CH₄).

During the multiphoton ionization process, a molecule/atom simultaneously absorbs multiple photons such that the total energy absorbed is sufficient for ionization. The absorption may not be truly simultaneous, but rather each photon of energy hν excites the molecule/atom to a virtual excited state with lifetime Δt=1/ν, where h is the Planck constant and ν is the photon frequency. To achieve multiphoton ionization, the photon flux must be great enough that the absorbed energy within the virtual state lifetime exceeds the ionization energy. Following the work of C. G. Morgan (Laser-Induced breakdown of gases, Rep. Prog. Phys., 38 (5), 1975) the threshold flux value can be approximated as:

$${F}_{th} = \frac{v}{σ} {( \frac{{N}_{c} ( k - 1 ) !}{{N}_{0} pV τ v} )}^{\frac{1}{k}} ,$$

where V is volume [m³], p is pressure [kg m⁻¹ s⁻²], N_{c} is the critical number of free ions, ν is the photon frequency [s⁻¹], τ is the pulse width [s], N₀ is Loschmidt's number 2.687×10²⁵ [m⁻³], σ is the photon absorbance cross section [m²], and k is the number of virtual energy levels required to reach the stable ionized state [dimensionless]. Defining the breakdown to occur when a fraction, δ of the atoms present in the volume is ionized,

$$\frac{{N}_{c} pV}{{N}_{0} pV} = δ \sim {10}^{- 3} ,$$

with the of δ being determined from previous experimental work, and incorporating the work of B. A. Tover (Theory of the ionization of gases by laser beams, Phys. Rev., 137 (6A), 1965) that the probability of photon arrival in the focal region follows a Poisson distribution we can then state the number of ions generated by a pulse, Nᵢ, to be:

$${N}_{i} = {N}_{0} pV τ v exp ( - \frac{F σ}{v} ) {( \frac{F σ}{v} )}^{k} k !$$

### If

$$\frac{{F}_{th} σ}{v} ≪ 1 ,$$

we can simplify the threshold flux to:

$${F}_{th} \approx \frac{v}{σ} {( \frac{δ k !}{τ v} )}^{\frac{1}{k}} .$$

A first order approximation of the threshold value can be obtained using typical values for the parameters—σ˜10⁻¹⁶ cm², ν˜10¹⁵ s⁻¹, k˜10, τ˜10⁻⁹ s, δ˜10⁻³−Fₜₕ≈10³⁰ cm⁻²s⁻¹ which matches, to the order of magnitude, experimental results.

During the multiphoton ionization process, most of the photons pass through the laser-beam focal volume without being absorbed. Once enough free electrons and ions are produced, the mechanism for ionization becomes dominated by cascade ionization, and finally a plasma is formed. During the cascade ionization process, the plasma becomes opaque (all photon radiation is absorbed or scattered) to the laser and nearly all photons are absorbed through the inverse Bremsstrahlung process in which a free electron absorbs a photon in the presence of heavy charged particles (atomic nuclei or ions).

The typical temporal profile of a flashlamp-pumped, Q-switched Nd:YAG laser with injection seeding is Gaussian, occasionally exhibiting some skewness. The peak photon flux occurs near the temporal midpoint of the pulse. Thus, a laser pulse with the minimum amount of energy required to generate a plasma (i.e., the peak photon flux exceeds the multiphoton ionization threshold), will produce the plasma at the moment the temporal midpoint of the pulse passes through the focal point. The plasma absorbs the remainder of the laser pulse, and therefore at least half of the laser pulse energy is deposited through the cascade ionization process.

If the laser pulse temporal profile can be reshaped such that the threshold photon flux Fₜₕ occurs as the very end of the laser pulse is reached—and thus the ionization mechanism switches from multiphoton to cascade ionization at the moment the tail end of the pulse passes through the focal point-energy deposition to the measurement medium (e.g., the measurement target) is minimized. As used herein, the term “target” refers to the intended use application. For example, when the methods and systems are used to analyze fine art, such as paintings, the painting is the target. When used to analyze gas in a combustion chamber, the gas is the target. It is believed that transforming the energy profile of a laser pulse can be accomplished through “pulse shaping” techniques for various end use targets.

In example embodiments of the disclosure, laser pulse shaping is accomplished by inducing an initial breakdown (i.e., plasma formation) along the beam path before the laser beam reaches the measurement location where the primary breakdown will occur, i.e. the measurement target. This initial breakdown occurs in a flow chamber under specific and controlled conditions, as described herein. Through adjustment and setting of the pressure, temperature, focusing optics used, and composition of the gases at the initial breakdown location, the timing of the transition from multiphoton ionization to cascade ionization can be adjusted relative to the laser temporal profile. Multiphoton ionization is a deterministic process and is predictable as opposed to the stochastic cascade ionization. Inverse Bremsstrahlung absorption during the cascade ionization process effectively acts a fast shutter, chopping the transmitted laser pulse to only that which passed through the focal point prior to the onset of cascade ionization. Additionally, this fast shutter is “passive” in the sense that it is induced by the laser pulse itself and therefore will occur in a consistent and repeatable manner for a given laser pulse profile and when the conditions at the initial breakdown are fixed.

The precise control over the energy content of the transmitted laser pulse, and thus on the amount of energy deposited at the target in the primary breakdown, expands the applicability of the LIBS technique in at least three ways specific to fuel-air ratio sensing in realistic combustor environments: It 1) facilitates fuel-air ratio measurements in combustible mixtures while inhibiting ignition, 2) facilitates LIBS measurements close to window/glass surfaces (as close as 5 mm), and 3) facilitates measurements at high (>2 atm) pressure by minimizing broadband emissions to optimize signal-to-noise ratio.

One advantage of the expanding LIBS techniques to temporal pulse shaping as described herein is the ability to measure fuel-air ratio in a combustible mixture without inducing ignition. Temporal pulse shaping can reduce the amount of energy deposited below that required for ignition, while still generating plasma emission signal suitable for quantification (e.g., of the fuel-air ratio and/or elemental analysis).

When LIBS is applied to enclosed geometries (such as those found in a combustor engine), it is desirable to be able to take measurements near to the inner window surface used to introduce the laser. The interface between the window surface and the interior media of the geometry represents a potential site of unwanted plasma formation when a focusing laser is passed through the window. The unintended breakdowns at the interface can cause catastrophic damage to the windows, requiring replacement, and potentially void the use of the window for LIBS measurements.

Temporal pulse shaping reduces the maximum photon flux in the pulse and thus reduces the likelihood of generating a plasma breakdown at the window surface interface. The focal point can safely be moved as close as 5 mm from the interface, while keeping the energy density below the breakdown threshold at the window-combustor interface surface but still generating a plasma at the measurement location. When LIBS is performed at pressures greater than atmospheric, the number density of molecules at the focal point is increased. This increases the probability of photon-matter interactions, and thus the transition from multiphoton ionization to cascade ionization occurs earlier in the temporal profile of the laser pulse. Additionally, the higher number density leads to increased collisional and Stark broadening of the atomic emission lines, as well as faster recombination of atomic species (created in LIBS process). As such LIBS measurements at high pressure can be difficult to quantify. Temporal pulse shaping allows for the control of the amount of laser-beam energy deposited at elevated pressure, reducing the strength of the electronic field and thus the amount of Stark broadening. Furthermore, this reduction in deposited energy leads to lower background continuum radiation from the plasma, allowing for quantifiable measurements at elevated pressure. The energy content of the shaped pulse can be rapidly and remotely adjusted in order to accommodate changing measurement conditions.

The use of an injection-seeded Q-switched laser can reduce shot-to-shot variation (i.e., from one laser pulse to the next) in the shaped laser pulse temporal profile relative to use without injection-seeding. The injection-seeded pulse consists of a single longitudinal cavity mode from the laser and thus has a smooth temporal profile. In an embodiment, laser pulse shaping with controlled inverse Bremsstrahlung absorption can be performed with lasers without injection seeding; however, the shaped pulse will have much higher shot-to-shot variation in energy content. Without injection seeding multiple longitudinal cavity modes are present in the laser pulse, and the resulting temporal profile may not be suitably smooth due to mode beating. Consequently, the temporal profile may not be consistent shot-to-shot in unseeded operation, and thus the transition from multiphoton ionization to cascade ionization varies in time relative to the pulse temporal profile. The use of an unseeded laser for pulse shaping can still greatly reduce the pulse width and the energy content of the transmitted pulse, but the shot-to-shot variation in pulse energy of the shaped pulse can be 100% of the mean or more. Laser pulse shaping without injection seeding may not be well suited for use cases which are highly sensitive to changes in pulse energy e.g. fuel-air ratio measurements while inhibiting ignition or other applications such as sampling solid-phase targets (e.g., a valuable painting) where target damage is a concern. The precise laser pulse shaping disclosed herein can be useful for analysis of any cultural heritage items where target damage is a concern. Furthermore, large variations in the transmitted pulse energy can lead to window damage when sampling near the window. In an embodiment, a picosecond laser can be used in the system of the disclosure. However, picosecond lasers are currently a relatively new and more expensive technology compared to nanosecond lasers.

Pulse shaping in which the controlled inverse absorption is conducted can be done at pressures greater than 6 atm. In an embodiment of the present disclosure, the pressure in flow chamber used for controlled inverse Bremsstrahlung absorption can be sub-atmospheric and is typically between 0.3 atm-1 atm. Sub-atmospheric pressures in the flow chamber allow for a later transition and a higher photon flux in the transmitted pulse. This lower pressure is beneficial for application in high-speed air-breathing propulsion (e.g., jet engine, rocket engine) research in which the measurement location is often at low pressures (e.g., <1 atm) and high temperatures (e.g., >600 K). In such a situation, the local gas number density is relatively low, and thus a higher photon flux is needed for the multiphoton ionization process. If a flow chamber with a pressure of greater than 6.8 atm is utilized, the shaped pulse will not reach the threshold photon flux for breakdown at the measurement location.

In embodiments of the present disclosure, a user can adjust the shaped laser pulse to meet the measurement requirements by adjusting the flow chamber pressure. Furthermore, this adjustment can be done in real-time and remotely. Many experimental facilities require users to be in a control room during experimental operations and thus being able to adjust laser energy remotely is often beneficial. Finally, in embodiments of the present disclosure, the inverse Bremsstrahlung shuttering can effectively be removed by reducing the flow chamber pressure to near vacuum condition. This will inhibit the initial breakdown and thus eliminate the shutter effect without the need to modify the beam path optics.

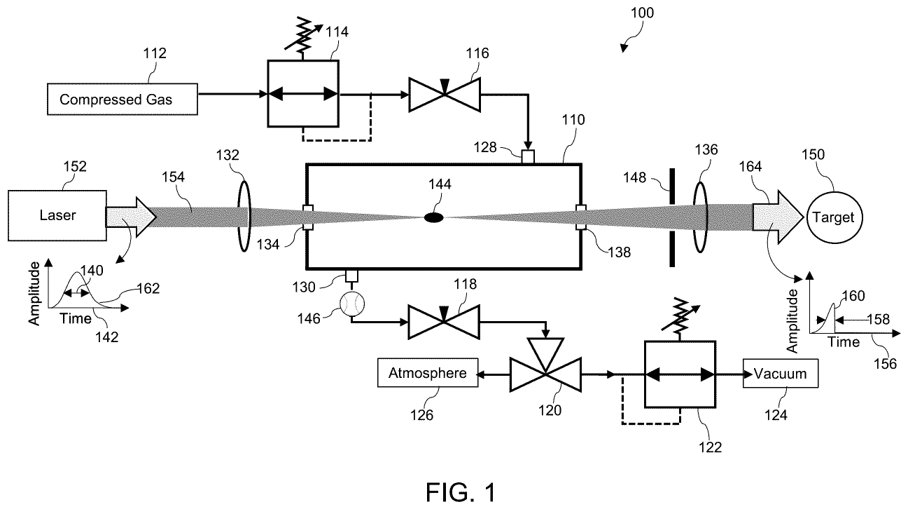

Referring to FIG. 1, there is shown a schematic diagram showing an example system 100 for temporal pulse shaping. The system 100 is described with apparatus components and methodology suitable for use in applications, including those benefiting from a total energy deposit below a minimum ignition energy while generating a plasma emission signal suitable for quantification.

The temporal pulse shaping system 100 includes a flow chamber 110 in which the pressure and flow rate of a gas in, or flowing through, can be precisely controlled. The gas pressure in the flow chamber 110 can be controlled to be either below or above ambient pressure. A gas supply 112, such as a compressed gas supply in a compressed gas cylinder is in fluid communication with the flow chamber 110. The gas supply 112 can supply a flow of gas to flow chamber 110 via a system of valves and regulators. In an embodiment, pressure regulator 114 and an upstream needle valve 116 can regulate gas flow upstream of the flow chamber 110.

The flow chamber 110 is in fluid communication with a vacuum source 124. Downstream of the flow chamber 110 gas flow can be regulated by a downstream needle valve 118 that governs flow to a three-way valve 120. The three-way valve 120 can regulate gas flow to the atmosphere 126, or to a vacuum source 124 via a vacuum regulator 122. In an embodiment, the vacuum regulator 122 can be operated remotely, enabling remote control of the gas pressure in the flow chamber 110. In an embodiment, a flow meter 146 can be utilized to suitably control gas flow, for example, to manage temperatures in the flow chamber 110. In an embodiment, the compressed gas is argon.

The flow chamber 110 has an entry port 128 that facilitates gas flow into the flow chamber 100, and an exit port 130 to facilitate gas flow out. A focusing lens 132 is operatively positioned for light beam modification from a laser 152 prior to entry into the flow chamber 110 at an entry aperture 134. The focusing lens 132 focuses the laser beam 154 to a location within the flow chamber 110, e.g., the location of initial breakdown 144. A collimation lens 136 is operatively positioned for light beam modification after exit from the flow chamber 110 through exit aperture 138 to collimate the laser beam. The entry aperture 134 and the exit aperture 138 can be optical access windows that allow laser light to pass through while blocking scattered light, e.g., light scattered off the plasma.

The entry aperture 134 and the exit aperture 138 can be optical access windows that are surface treated to be antireflective (R<0.1%) for the wavelength of the laser used. In an embodiment, the entry aperture 134 and the exit aperture 138 comprise 1-inch diameter circular-shaped windows having antireflective treatment (e.g., nanostructure random anti-reflection) for 532 nm light. In an embodiment, the distance between the interior surfaces of the entry aperture 134 and the exit aperture 138 is 150 mm, but generally can be dimensioned to match the lens pair (focusing lens 132 and comminating lens 136) such that the initial breakdown 144 can occur near the center of the flow chamber 100 and the beam spot size on the optical access windows of the entry aperture 134 and the exit aperture 138 is large enough that the energy density is below the damage threshold (a typical laser-induced-damage threshold (LIDT) for fused silica with a 10 ns FWHM pulse of 532 nm light is 280 J/cm²). By way of example, for a lens pair having respective focal lengths of 125 mm and 180 mm, or 100 mm and 125 mm, a spacing of 150 mm between inner surfaces of the entry aperture 134 and the exit aperture 138 can result in the desired spot size on the windows.

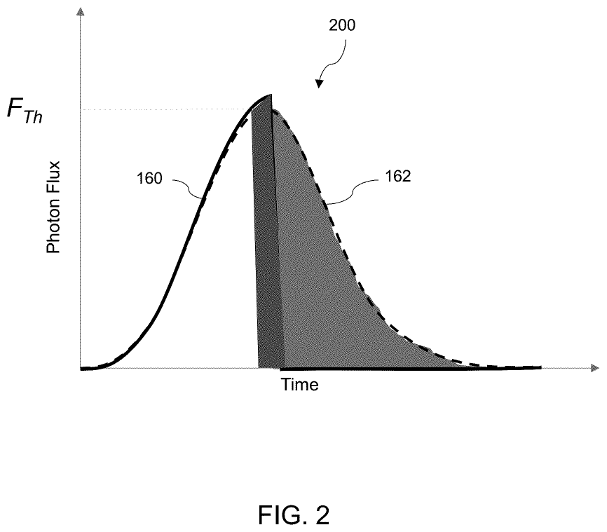

For gas-phase matter, such as that found in the flow chamber, i.e. the location of initial breakdown 144, the transition from optically thin (photons are not absorbed and pass through the focal point) to optically thick or opaque (photons are absorbed or scattered) occurs over 10 s of picoseconds, creating a sharp trailing edge of the laser pulse in time at exiting the flow chamber 110, as schematically represented as shaped pulse 160 at graph 156 and in solid line on graph 200 in FIG. 2. This shaped, or shuttered, pulse 160 at the location of the target 150 can have a full-width half-max (FWHM) pulse width 158 of between about 0.9 and about 1.2 ns, a pulse energy of about 6-25 mJ, and a maximum photon flux just below the threshold for multiphoton ionization at the target. This threshold is a function of the gas composition and pressure within the flow chamber 110 and the laser beam 154 size at the focal point. Therefore, for a given selection of focusing optics, control of the chamber gas composition and pressure effectively controls the shuttered pulse peak photon flux. By adjusting these controls to a predetermined settings and levels, a shuttered pulse can be generated that produces a stable primary breakdown in the desired measurement environment with minimized energy deposition. For solid-phase targets control over the shuttered pulse energy content can be used to control the amount of material ablated during the plasma formation-thus controlling the depth/area of the measurement or protecting the target. Typically, the required energy for performing LIBS of solid matter is less than that required for gas-phase matter, as such a shorter focal length focusing lens or higher pressure in the flow chamber would be required to lower the energy content of the shaped pulse.

The laser 152 can be an injection-seeded laser. In an embodiment, the laser is an injection-seeded, flashlamp-pumped, frequency-doubled Nd:YAG laser operating at 30 Hz pulse repetition frequency producing a laser pulse at 532 nm with pulse energy of 200-250 mJ and a full-width half-max (FWHM) pulse width 140 of about 8 ns, indicated as pulse 162 in representative graph 142 and in dashed line in graph 200 of FIG. 2. The Gaussian shape of pulse 162 can have a maximum photon flux, F_{Th}, such that at least ½ of the pulse energy is deposited.

The focusing lens 132 can be a plano-convex singlet lens and can be configured for pulse shaping. The focusing lens 132 focal length can be selected based on the desired measurement conditions and measurement focusing optic, typically 75 mm-150 mm. The collimating lens 136 can be a cemented achromatic doublet lens and can have a focal length equal to or greater than that of the focusing lens 132. The lens pair selection in effect sets the tuning range for the shuttered pulse energy which can be tuned by changing the pressure of the gas in the flow chamber 110.

The pressure regulator 114 can be used to manage the pressure upstream of flow chamber 110 to a desired chamber pressure for desired pulse characteristics. The needle valves (e.g., upstream needle valve 116 and downstream needle valve 118) can be used to generate a pressure drop either upstream of the flow chamber (e.g., for flow chamber pressures below atmospheric) or downstream of the flow chamber (e.g., for flow chamber pressures above atmospheric).

The flow meter 146 is used to measure the rate of gas flow through the system. The inverse Bremsstrahlung absorption process deposits energy into the gas and thus can cause heating of the flow chamber 110. If the gas at the focal point within the flow chamber is heated, the interaction between the gas and the laser pulse will change. To maintain consistent transmitted pulse attributes, a flow velocity can be managed such that the gases at the breakdown location are refreshed between laser pulses, and thus consistent for every pulse. A suitable flow velocity can be determined by the laser repetition rate and the geometry of the flow chamber. The three-way valve 120 can be used to direct the gas flow from the flow chamber 110 either to atmosphere 126 or through the vacuum regulator 122, allowing for the pressure in the flow chamber to be changed, e.g., from sub-atmospheric to greater than atmospheric, remotely. Further, the vacuum regulator 122 can be operated (including remotely) to generate a low pressure such that flow is produced for flow chamber at pressures below atmospheric.

In an embodiment, argon is used as the compressed gas of gas supply 112 as opposed to dry air or nitrogen, as argon offers superior performance in terms of total absorption following the initiation of inverse Bremsstrahlung absorption. In argon, once the transition from multiphoton to cascade ionization and then inverse-Bremsstrahlung, the plasma stays optically thick or opaque (all photons are absorbed or scattered) for the duration of the laser pulse. If air is used in the flow chamber, after transition the plasma can be initially optically thick or opaque; however, the optical density begins to decrease, and photons are able to pass through the plasma later in the laser pulse temporal profile. The resulting temporal laser profile then has an initial sharp cutoff, followed by a low level of radiation that extends for the duration of the nanosecond laser pulse. An additional benefit of using argon is that the breakdown of argon does not create reactive species. When oxygen is present, the energy deposited during the controlled inverse Bremsstrahlung absorption can generate reactive species such as atomic oxygen, ozone, and/or oxides of nitrogen (and even nitric acid when water vapor is also present). Such species can cause accelerated deterioration of antireflective coatings, window substrates, and sealing materials of the flow chamber 110.

The two lenses, i.e., the focusing lens 132 and the collimation lens 136, can be operatively positioned on either side of the flow chamber 110 along the laser beam propagation path. The focusing lens 132 is operatively positioned between the laser 152 and the flow chamber 110, and the collimating lens 136 is operatively positioned between the flow chamber 110 and the measurement target 150. The two lenses can be of any suitable type and material depending on the laser used. For a 532 nm laser with an input pulse of 200 mJ with FWHM of 8 ns, the focusing lens can be a 100 mm focal length best-form, fused silica lens. The collimating lens can be a 125 mm focal length cemented achromatic doublet, fused-silica lens. The focal length of the collimating lens 136 can be longer than that of the focusing lens 132 to increase the diameter of the transmitted laser beam 154, allowing for tighter focusing (i.e., smaller spot size) at the measurement target 150 position (i.e., the primary breakdown 164 location). Depending on the optical access of a target device (e.g., combustor), the lenses can also be matched in focal length. This would be appropriate if the clear aperture of the optical access is a limiting factor. For this lens configuration the energy tuning range of the shuttered laser pulse is 3 mJ-12 mJ. A given lens configuration will not be appropriate for all use cases, rather consideration should be given to the desired use case when selecting a lens. The focusing lens effectively sets the energy range the shaped pulse may be controlled within by changing the flow chamber pressure. The collimating lens focal length and type impact the beam characteristics such as diameter, that may be important depending on the use case. For gas phase LIBS in general increasing the diameter of the beam allows for a smaller beam spot size—and thus a lower breakdown threshold energy. With a lens pair consisting of a plano-convex singlet 125 mm focusing lens and a 180 mm achromatic doublet collimating lens the energy tuning range is 6 mJ-25 mJ and would be appropriate for use cases where more energy is required in the shaped pulse.

At least one adjustable aperture 148 can be placed between the flow chamber 110 and the collimating lens 136. The aperture(s) 148 can be used to block scattered laser light and emissions from the plasma at the primary breakdown 164 at target 150. In an embodiment, an additional aperture can be placed after the collimating lens 136, set to the diameter of the collimated beam. Without the apertures, scattered light and emissions from the plasma can propagate through the beam path and potentially interfere with the measurement.

The inclusion of injection seeding in the laser system used with pulse shuttering can result in LIBS being suitable for many potential applications. If pulse shuttering were to be used with a normal non-injection seeded (multi-mode) laser, the temporal profile of the laser pulse might contain many spikes in instantaneous energy content. As such, the time relative to the start of the laser pulse at which the ionization would transition from a multiphoton to a cascade ionization process at the initial breakdown 144 could vary highly between pulses, and thus the energy content and pulse width of the shaped pulses 160 could vary greatly. The addition of injection seeding allows consistent transition of the ionization at the initial breakdown 144, resulting in a stable energy content in the shaped pulse 160. This consistency permits tuning the laser for use in combustible environments and near window surfaces where operating either near the ignition threshold or the laser-induced-damage threshold is required for safety. Additionally, fine control of the shaped pulse energy content allows for solid-phase LIBS in cases where specific depths of ablation are needed or where target damage is a concern (e.g. analysis of objects of high monetary or cultural value).

A representative system 100 for temporal shaping of a laser pulse can be illustrated in the environment of a scramjet cavity flame holder with Mach 2 core flow and stagnation condition of P=483 kPa and T=589K. In this example, the laser source 152 is an injection-seeded, flashlamp-pumped, frequency-doubled Nd:YAG laser operating at 30 Hz pulse repetition frequency. The output is at 532 nm with pulse energy of 200 mJ and pulse width 8 ns FWHM. The focusing lens 132 is a fused-silica best-form lens with focal length f=100 mm and a narrowband antireflective (AR) coating for 532 nm. The collimating lens 136 is a fused-silica cemented achromatic doublet with focal length f=125 mm and a broadband AR coating 500 nm-800 nm. A measurement focusing optic is either a f=150 mm plano-convex lens, an f=100 mm achromatic doublet, or a f=75 mm best-form lens. For all lenses, the lens substrate is fused silica, and the lens has an AR coating for 500 nm-800 nm. The pressure in the flow chamber 110 is set between 0.3 atm and 1 atm depending on measurement-location conditions, and the flow rate of the argon is >0.3 liters/min. With such a configuration, the amount of energy deposited for the measurement is limited to <2 mJ, allowing for derivation of fuel-air ratio (even on a single-shot basis) without resulting in ignition/sustained combustion.

Continuing the example for use in a scramjet cavity flame holder, the setup for the temporal pulse shaping is integrated into a LIBS setup containing a laser source, optics, and collection system. The optics for the pulse shaping are selected based on the relevant parameters of the measurement environment. For measurements in scramjet combustor, the argon pressure within the chamber is set to slightly above atmospheric. The pressure in the flow chamber 110 is set using the remote control of the vacuum regulator 122 so that primary breakdown 164 is achieved in the measurement location at target 150 with minimum deposited energy. Once this level is determined, normal operation ensues with the LIBS system (for collection of desired fuel-air ratio data). If the conditions at a certain point or certain operating condition change the local conditions sufficiently such that stable breakdown with minimum deposited energy is no longer achieved, the chamber pressure can be remotely adjusted by control of the vacuum regulator and/or input pressure.

The configuration of the example setup including focusing and collimating optics, flow chamber geometry, flow chamber windows, and laser source, can be adjusted to optimize the temporal pulse shaping for a specific measurement environment. The antireflective (AR) treatment can be matched to the laser wavelengths. The laser wavelength can be determined by the desired measurement composition, phase state, and collection spectral window. The focal lengths for the chamber focusing and collimating optics can be determined by the desired pulse profile, i.e., shorter focal lengths promote faster transition to inverse Bremsstrahlung absorption.

If the flow chamber 110 pressure is not required to be less than atmospheric, the setup can be greatly simplified by the removal of the vacuum regulator 122. In such a situation the pressure in the flow chamber 110 can be set by the regulation of the upstream pressure regulator 114 and the orifice size of the upstream needle valve 116. The downstream needle valve 118 (if utilized) and/or the three-way valve 120 (if utilized) can facilitate outflow gas to the atmosphere. This setup can be appropriate for applications for solid-phase LIBS, liquid-phase LIBS, or high-pressure gas-phase LIBS.

The focus of the development for temporal pulse shaping with controlled inverse Bremsstrahlung absorption is suitable for applications in combustible environments, at pressures where Stark broadening and fast recombination cause difficulties with quantification, and at locations near window surfaces, though there are many applications in the wider field of LIBS. The setup could be used for solid-phase LIBS to quickly adjust the amount of laser energy deposited and thus the depth of the laser-induced crater formation, which is especially important when damage at the target is a concern (e.g., when the object investigated has high value). The setup could also be used for any laser diagnostic technique wherein a picosecond range pulse shape is desired-especially in instances wherein a sharp trailing edge is beneficial-when there is access to a Q-switched laser.

As discussed, it becomes clear that nanosecond laser pulses (e.g., 6-8 ns FWHM, produced by a Q-switched, frequency-doubled Nd:YAG laser) can be chopped using the inverse-Bremsstrahlung photon absorption process in a chamber with variable pressure. The inverse-Bremsstrahlung process that quickly absorbs the majority of the laser pulse energy is triggered by focusing the pulse in the pressure chamber. Prior to the initiation of the inverse-Bremsstrahlung process, the gaseous medium in the cell is transparent, while it suddenly becomes opaque with the inverse-Bremsstrahlung process activated; therefore, the pressure cell can be used as a virtual optical shutter. The shutter “closing time” depends strongly on the pressure of the cell and the laser pulse energy and thus can be controlled.

An important aspect of the system 100 is that the energy content of the shuttered pulse can be remotely tuned on the fly for varying conditions at the desired measurement location. When the energy is being tuned, there are a number of considerations-keeping the amount of energy deposited below the ignition (or damage) threshold, maintaining an acceptable signal to noise ratio, ensuring consistent breakdown. All of these considerations are dependent on the specific experiment. The specific parameters of the device which are used to tune the energy level include the focal lengths of the lens pair and the pressure of the flow chamber. Therefore, these parameters are not a “design choice” but must be selected based on the conditions, and indeed the beneficial aspects of the system lie in the fact that through this tuning LIBS becomes applicable to many more desired measurement conditions and situations.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Those skilled in the art will recognize that the embodiments herein can be practiced with modification within the spirit and scope of the appended claims.

What is claimed is:

1. A system for temporal shaping of a laser pulse comprising,
a flow chamber, the flow chamber having an entry aperture and an exit aperture;
a compressed gas supply in fluid communication with the flow chamber;
a vacuum source in fluid communication with the flow chamber;
a laser positioned in operative alignment to produce a laser beam that enters the entry aperture and exits the exit aperture;
a focusing lens operatively positioned to focus the laser beam through the entry aperture;
a collimating lens operative positioned to collimate the laser beam exiting the exit aperture; and
a vacuum regulator in fluid communication with the vacuum source for regulating a pressure in the flow chamber to less than 1 atm.

2. The system of claim 1, wherein the flow chamber is a pressure chamber.

3. The system of claim 1, wherein the compressed gas supply is argon.

4. The system of claim 1, wherein the laser is an injection-seeded Q-switched laser.

5. The system of claim 4, wherein the laser is an injection-seeded, flashlamp-pumped, frequency-doubled Nd:YAG laser operating at 30 Hz pulse repetition frequency with an output at 532 nm with pulse energy of 200 mJ and a full-width half-max (FWHM) pulse width of 8 ns.

6. The system of claim 1, wherein the focusing lens focuses the laser beam for initial breakdown in the flow chamber.

7. The system of claim 1, wherein the focusing lens and the collimating lens are positioned at a predetermined distance to achieve a predetermined shuttered pulse energy.

8. The system of claim 1, wherein the collimating lens has a focal length equal to the focal length of the focusing lens.

9. The system of claim 1, wherein the collimating lens has a focal length greater than the focal length of the focusing lens.

10. A system for temporal shaping of a laser pulse comprising,
a variable pressure flow chamber, the flow chamber having an entry port, an exit port, a first optical access window and second optical access window, the second optical access window being spaced at a fixed distance from the first optical access window, wherein a midpoint of the fixed distance defines a center portion of the flow chamber;
a compressed argon gas supply in fluid communication with the entry port;
a vacuum source in fluid communication with the exit port;
a laser positioned in operative alignment to produce a laser beam that enters the first optical access window and exits the second optical access window;
a focusing lens operatively positioned to focus the laser beam before the first optical access window, the focusing lens having a focusing lens focal length;
a collimating lens operative positioned to collimate the laser beam after the second optical access window, the collimating lens having a collimating lens focal length; and
wherein the fixed distance, the focusing lens focal length, and the collimating lens focal length are configured such that initial breakdown from a laser beam occurs at the center portion of the variable pressure flow chamber.

11. The system of claim 10, further comprising a pressure regulator and a vacuum regulator, the pressure regulator and the vacuum regulator being controlled to determine the pressure in the variable pressure flow chamber.

12. The system of claim 10, wherein the compressed gas supply flows from the entry port to the exit port.

13. The system of claim 10, wherein the laser is an injection-seeded, flashlamp-pumped, frequency-doubled Nd:YAG laser operating at 30 Hz pulse repetition frequency with an output at 532 nm with pulse energy of 200 mJ and a full-width half-max (FWHM) pulse width 140 of 8 ns.

14. The system of claim 10, wherein the focusing lens and the collimating lens are positioned at a predetermined distance to achieve a predetermined shuttered pulse energy.

15. The system of claim 10, wherein the collimating lens has a focal length equal to the focal length of the focusing lens.

16. The system of claim 10, wherein the collimating lens has a focal length greater than the focal length of the focusing lens.

17. A method for temporal shaping of a laser pulse, comprising,
suppling a flow of a gas through a pressurizable flow chamber;
directing an injection seeded pulsed laser beam through a focusing lens into the pressurizable flow chamber;
adjusting the pressure in the pressurizable flow chamber and setting the focal length of the focusing lens to control the timing and location of the transition of a focused laser beam from multiphoton ionization to cascade ionization;
inducing initial breakdown in the pressurizable flow chamber with controlled inverse Bremsstrahlung absorption to produce a shaped pulse; and
collimating the shaped pulse through a collimating lens.

18. The method of claim 17, wherein the gas is argon, and the adjusting step is determined by temperature in the pressurizable flow chamber.

19. The method of claim 17, wherein the pressure in the pressurizable flow chamber is maintained between about 0.3 atm and about 1 atm.

20. The method of claim 17, wherein the injection seeded laser pulse has shaped pulse has a full-width half-max pulse width 140 of 8 ns and the shaped pulse has a full-width half-max pulse width 158 of between about 0.9 and about 1.2 ns.
